(19) United States
(12) Patent Application Publication
(10) Pub. No.: US 2008/0252458 A1
(43) Pub. Date: Oct. 16, 2008

(54) ELECTRONIC DEVICE

(75) Inventors: Jung-Chi Chen, Hsinchu (TW); Che-Hsueh Chen, Hsinchu (TW); Wen-Chi Teng, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/849,372

(22) Filed: Sep. 4, 2007

(30) Foreign Application Priority Data
Apr. 10, 2007 (TW) 96205660

(51) Int. Cl. G08B 13/14

(52) U.S. Cl. 340/572.1

(57) ABSTRACT

An electronic device including an electronic device body, a remote unit, an identification unit and a tag is provided. The remote unit has a first switch. The identification unit is disposed in the electronic device body, and the tag is disposed in the remote unit. When the remote unit is close to the electronic device body and the first switch is turned on, the identification unit is capable of identifying the tag to activate the electronic device body. Because the electronic device body is activated after the tag is identified by the identification unit, the invention is able to reduce the theft rate of the electronic device body by separately storing the electronic device body and the remote unit.

### CROSS-REFERENCE TO RELATED APPLICATION

This application claims the priority benefit of Taiwan application serial no. 96205660, filed Apr. 10, 2007. All disclosure of the Taiwan application is incorporated herein by reference.

### BACKGROUND OF THE INVENTION

1. Field of the Invention

The present invention relates to an electronic device, and more particularly, relates to an electronic device with an identification unit.

2. Description of Related Art

Along with the advancement of science and technology, various electronic devices such as projection apparatus, notebook computer, digital camera, digital video camcorder, digital video disc player (DVD player) and etc are widely used. To meet the demand for portability, the electronic devices are designed to be light, small, compact and thin.

However, although fancy and tiny electronic device has good portability, it is also likely to be stolen, therefore, at present the anti-theft design of an electronic device is also well considered.

For example, the common anti-theft design of a projection apparatus is using a chain lock or a cipher lock. Besides, some manufacturers dispose chip lock in projection apparatus, and use the engagement between a keypad and the projection apparatus as the switch of the chip lock to form an anti-theft mechanism.

However, among the above anti-theft technology, chain lock is very easily broken by thieves, so using chain lock to lock a projection apparatus is not so effective. In addition, when a thief sees a projection apparatus with cipher lock, the thief usually steals the projection apparatus first and then try to crack the password of the cipher lock, therefore the anti-theft effectiveness is not so effectively good either.

In addition, for the projection apparatus with cipher lock, although users prevent the projection apparatus from turning on by simply taking away the keypad to lock the projection apparatus, however, when the keypad is taken away, the chip lock under the keypad of the projection apparatus is exposed. Not only the appearance of the projection apparatus is not good, but also the chip lock is very easily damaged.

In addition, since a ceiling mount type projection apparatus is usually mounted on the ceiling, users usually can't easily reach the projection apparatus, so the ceiling mount type projection apparatus usually is controlled with remote control instead of being equipped with a keypad. Therefore, because a chip lock is not easy to remove, so a chip lock cannot be used in a ceiling mount type projection apparatus. What's more, after a thief steals the projection apparatus, he/she usually controls the projection apparatus with a universal remote control device. Therefore design a chip lock on a projection apparatus does not reduce the theft rate effectively.

### SUMMARY OF THE INVENTION

The present invention is directed to an electronic device, wherein an electronic device body is only activated by a corresponding remote unit, thus the theft rate of an electronic device is reduced by separately storing the electronic device body and the remote unit.

The present invention is directed to an electronic device, wherein the electronic device body is only activated when the electronic device body is connected to a corresponding cable. Therefore the theft rate of the electronic device body is reduced by separately storing the electronic device body and the cable.

The present invention provides an electronic device comprising an electronic device body, a remote unit, an identification unit and a tag. The remote unit comprises a first switch. The identification unit is disposed in the electronic device body, and the tag is disposed in the remote unit. When the remote unit is close to the electronic device body, and the first switch is turned on, the identification unit is capable of identifying the tag to activate the electronic device body.

The present invention provides an electronic device comprising an electronic device body, a cable, an identification unit and a tag. The electronic device body comprises a switch and a first connector, the cable comprises a second connector, and the second connector is capable of connecting to the first connector. The identification unit is disposed in the electronic device body, and close to the first connector, and the tag is disposed in the second connector. When the second connector is connected to the first connector, and the switch is turned on, the identification unit is capable of identifying the tag to activate the electronic device body.

In the present invention, the identification unit in the electronic device body identifies the tag of the remote unit. And when the identification signal transmitted from the tag is same as the identification code stored in the storage unit of the identification unit, and then the electronic device body is activated. Therefore, the present invention reduces the theft rate of an electronic device body by separately storing the electronic device body and the remote unit.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a perspective view of an electronic device according to a first embodiment of the present invention.

FIG. 2 is a block diagram of an electronic device with an active RF tag according to the first embodiment of the present invention.

FIG. 3 is a block diagram of an electronic device with a passive RF tag according to a second embodiment of the present invention.

FIG. 4 is a perspective view of an electronic device according to a third embodiment of the present invention.

FIG. 5 is a block diagram of an electronic device with a passive RF tag according to the third embodiment of the present invention.

FIG. 6 is a perspective view of an electronic device according to a fourth embodiment of the present invention.

FIG. 7 and FIG. 8 respectively are block diagrams of two electronic devices with passive RF tags according to the fourth embodiment of the present invention.

FIG. 9 is a block diagram of an electronic device with an active RF tag according to a fifth embodiment of the present invention.

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

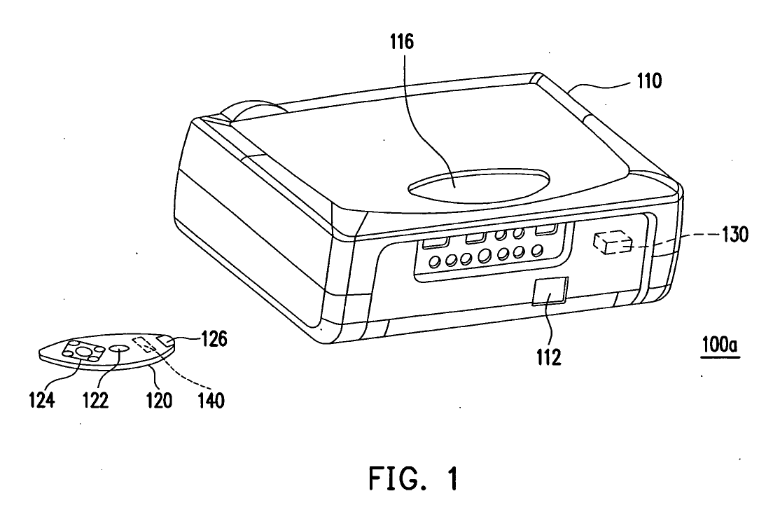

FIG. 1 is a perspective view of an electronic device according to a first embodiment of the present invention. Referring to FIG. 1, an electronic device 100a includes an electronic device body 110, a remote unit 120, an identification unit 130 and a tag 140. The remote unit 120 comprises a first switch 122. The identification unit 130 is disposed in the electronic device body 110, and the tag 140 is disposed in the remote unit 120. When the remote unit 120 is close to the electronic device body 110 and the first switch 122 is turned on via for example a press method, the identification unit 130 is capable of identifying the tag 140 to activate the electronic device body 110.

Although the electronic device 100a shown in FIG. 1 is a projection apparatus, however the present invention is not limited there-to as such. For example, the electronic device 100a also includes electronic devices such as a notebook computer, a digital camera, a digital video camcorder and a DVD player and etc.

The identification unit 130 in the present embodiment is, for example, a radio frequency identification (RFID) unit, and the identification unit 130 is, for example, disposed inside the electronic device body 110. The tag 140 is, for example, a radio frequency (RF) tag, and the tag 140 is, for example, disposed inside the remote unit 120.

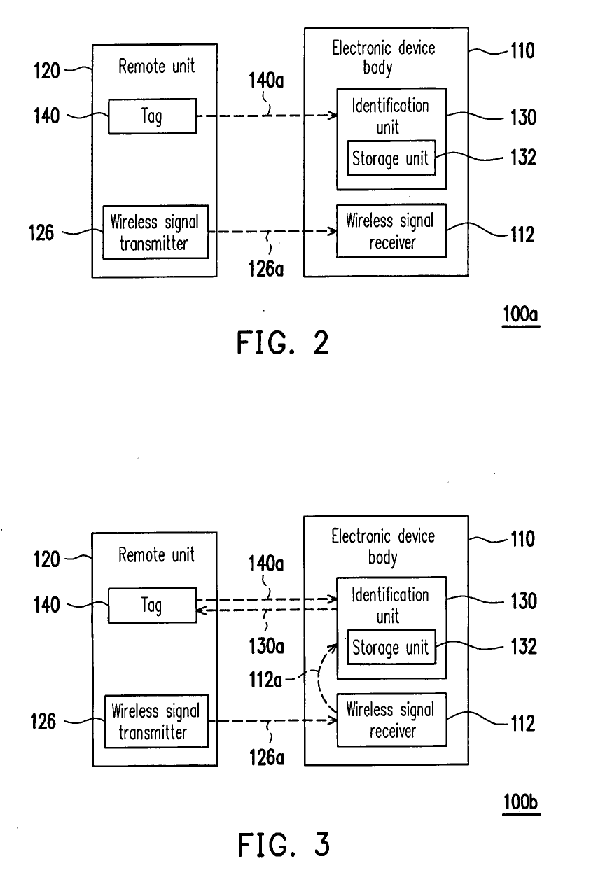

FIG. 2 is a block diagram of an electronic device with an active RF tag according to the first embodiment of the present invention. Referring to FIG. 1 and FIG. 2, in the present embodiment, the tag 140 is, for example, an active RF tag, and the tag 140 is capable of transmitting an identification signal 140a. When the remote unit 120 is close to the electronic device body 110 and the identification signal 140a is within the reading range of the identification unit 130, the identification unit 130 receives and identifies the identification signal 140a by turning on the first switch 122 via for example a press method.

More specifically, the identification unit 130 has a storage unit 132. The storage unit 132 stores an identification code of the tag 140, and the identification unit 130 is capable of comparing the identification signal 140a and the identification code. When the identification signal 140a transmitted by the tag 140 is within the reading range of the identification unit 130 and users press the first switch 122, the identification unit 130 receives the identification signal 140a. Then the identification unit 130 compares the identification signal 140a with the identification code. If the identification signal 140a and the identification code are the same, then the electronic device body 110 is activated; if the identification signal 140a and the identification code are different, then the electronic device body 110 is not activated.

It should be noted that in different electronic devices 100a, different tags 140 transmit different identification signals 140a, and every storage unit 132 stores the identification code of the corresponding tag 140. Therefore the electronic device bodies 110 and remote units 120 form a mapping configuration. In other words, pressing the first switch 122 on the remote unit 120 only activates the corresponding electronic device body 110. Since the RF tag is not easy to be duplicated, therefore when users store the electronic device body 110 and the remote unit 120 separately, and when a thief steals only the electronic device body 110, the electronic device body 110 cannot be activated. Therefore the present invention effectively reduces the theft rate of the electronic device body 110. And since pressing the first switch 122 on the remote unit 120 only activates the corresponding electronic device body 110, therefore users just need to keep the remote unit 120 in a safe place to achieve an anti-theft effect. Therefore, the present invention further makes stowing the electronic device body 110 easier.

In addition, the remote unit 120 further includes a plurality of buttons 124 and a wireless signal transmitter 126, and the electronic device body 110 includes a wireless signal receiver 112, and a wireless signal 126a is transmitted between the wireless signal transmitter 126 and the wireless signal receiver 112. When users press the button 124, the remote unit 120 transmits the wireless signal 126a to the wireless signal receiver 112 through the wireless signal transmitter 126 to remote control the electronic device body 110. In the present embodiment, the wireless signal transmitter 126 is, for example, an infrared (IR) transmitter, and the wireless signal receiver 112 is, for example, an IR receiver, and the wireless signal 126a is, for example, an IR signal.

FIG. 3 is a block diagram of an electronic device with a passive RF tag according to a second embodiment of the present invention. Referring to FIG. 1 and FIG. 3, the electronic device 100b of the second embodiment is similar to the electronic device 100a of the first embodiment described with reference to FIG. 2 except for the tag 140 of the electronic device 100b is a passive RF tag, and the activation procedure.

In the present embodiment, when users turn on the first switch 122 via, for example, a press method, the wireless signal transmitter 126 is capable of transmitting a wireless signal 126a, and the wireless signal receiver 112 is capable of receiving the wireless signal 126a. Next the wireless signal receiver 112 transmits a first signal 112a to the identification unit 130 to make the identification unit 130 to transmit a second signal 130a to the tag 140. The first signal 112a is, for example, a control signal for controlling the identification unit 130. The identification unit 130 is, for example, a RFID unit, while the tag 140 is, for example, a RF tag, and the second signal 130a is, for example, a RF signal.

After the tag 140 receives the second signal 130a, the tag 140 transmits an identification signal 140a, and the identification unit 130 receives and identifies the identification signal 140a. And the manner that the identification unit 130 identifies the identification signal 140a is the same as the first embodiment, therefore this description will not be repeated.

Similarly, since pressing the first switch 122 on the remote unit 120 only activates the corresponding electronic device body 110, therefore the present invention reduces the theft rate of the electronic device body 110.

It is worth to describe that, as known by those skilled in the art, the terminology “the remote unit 120 is close to the electronic device body 110” and the terminology alike used in the present invention refer to that the distance between the remote unit 120 and the electronic device body 110 is close enough for the wireless signal receiver 112 to receive the wireless signal 126a transmitted by the wireless signal transmitter 126 and/or for the identification unit 130 to receive the identification signal 140a.

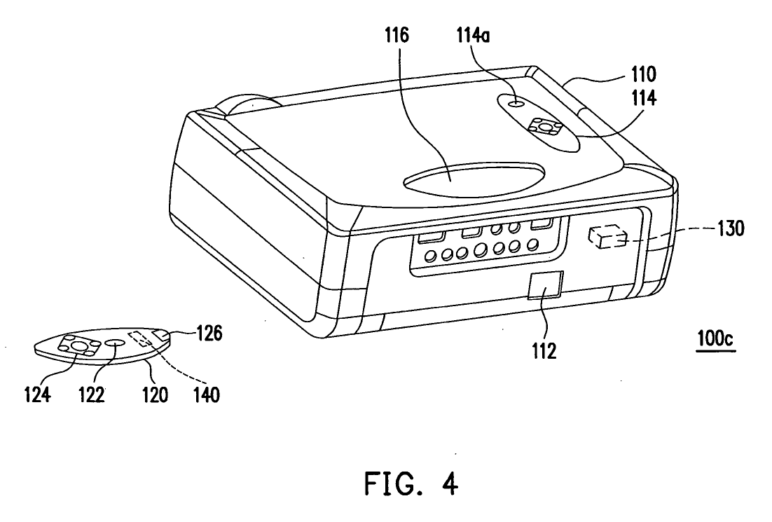

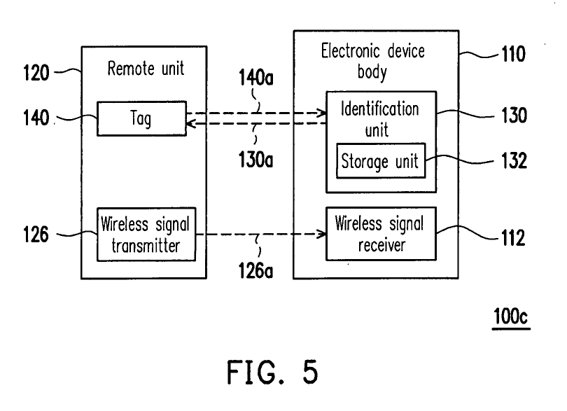

FIG. 4 is a perspective view of an electronic device according to a third embodiment of the present invention. FIG. 5 is a block diagram of an electronic device with a passive RF tag according to the third embodiment of the present invention. Referring to FIG. 4 and FIG. 5, the electronic device 100c of the third embodiment is similar to the electronic device 100b of the second embodiment described with reference to FIG. 3 except for a keypad 114 disposed on the electronic device body 110 which is capable of controlling the electronic device body 110.

In the present embodiment, the keypad 114 comprises a second switch 114a. When the remote unit 120 is close to the electronic device body 110, and the second switch 114a is turned on via, for example, a press method, the identification unit 130 is capable of identifying the tag 140 to activate the electronic device body 110. Therefore users activate the electronic device body 110 by pressing the first switch 122 on the remote unit 120 or pressing the second switch 114a on the keypad 114.

More specifically, when users press the second switch 114a, the identification unit 130 transmits a second signal 130a to the tag 140. Similarly, the identification unit 130 is, for example, a RFID unit, and the tag 140 is, for example, a RF tag, and the second signal 130a is, for example, a RF signal. After the tag 140 receives the second signal 130a, the tag 140 transmits the identification signal 140a, and the identification unit 130 receives and identifies the identification signal 140a. The method that the identification unit 130 identifies the identification signal 140a is the same as that of the first embodiment, therefore it will not be described again.

Similarly, since pressing the first switch 122 on the remote unit 120 or the second switch 114a on the keypad 114 both only activate the corresponding electronic device body 110, therefore the present invention reduces the theft rate of the electronic device body 110.

However, the present invention is not limited to the above embodiment. For example the keypad 114 may not have the second switch 114a, so that the electronic device body 110 is only activated by pressing the first switch 122 of the remote unit 120.

In addition, referring to FIG. 1 and FIG. 4 again, the electronic device body 110 farther has a recess 116, and the remote unit 120 is disposed in the recess 116. Moreover, the remote unit 120 further comprises a battery (not shown). When the remote unit 120 is disposed in the recess 116, the battery is capable of being charged through the electronic device body 110.

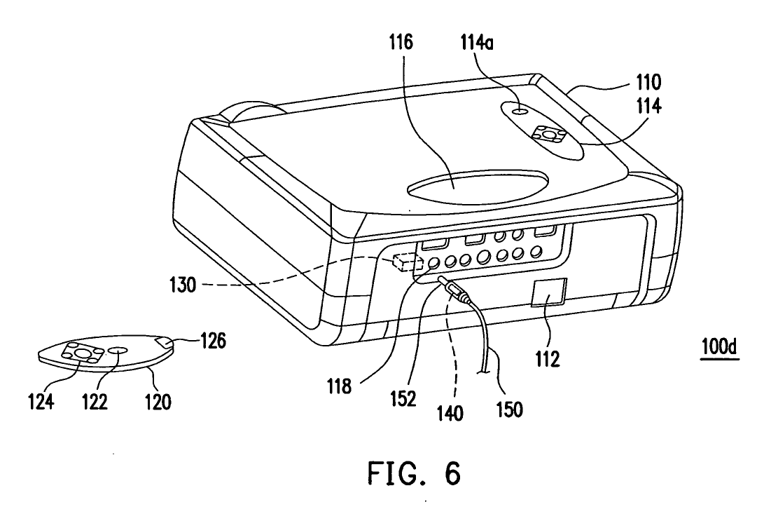

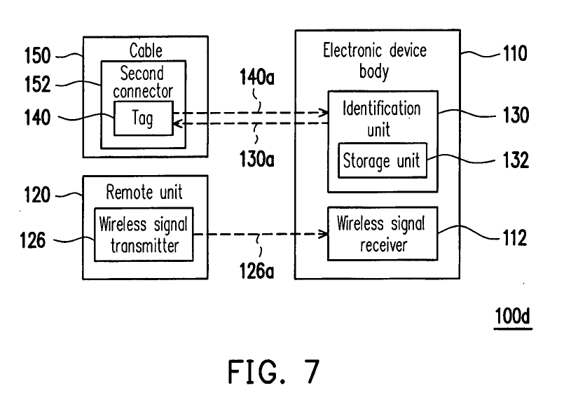

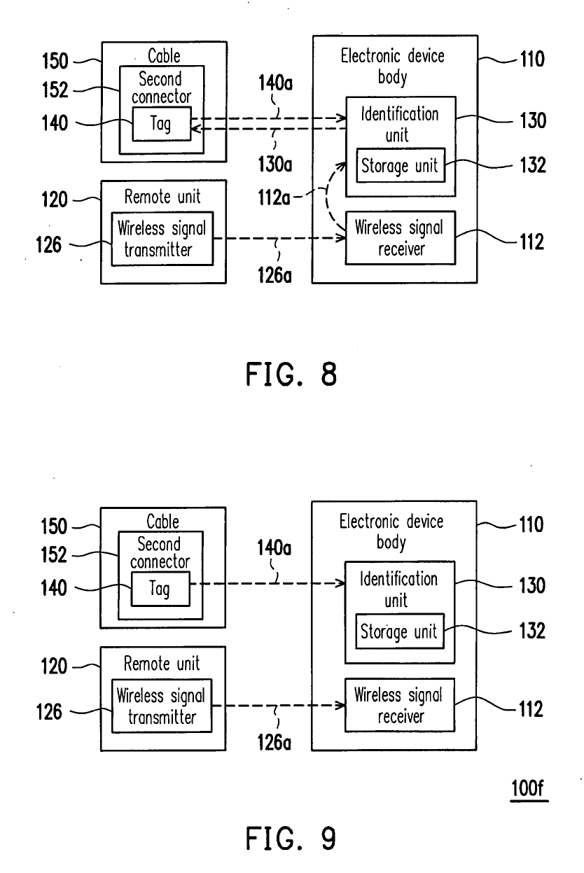

FIG. 6 is a perspective view of an electronic device according to a fourth embodiment of the present invention, and FIG. 7 and FIG. 8 respectively are block diagrams of two electronic devices with passive RF tags according to the fourth embodiment of the present invention. First, referring to FIG. 6 and FIG. 7, the electronic device 100d of the fourth embodiment is similar to the electronic device 100c of the third embodiment described with reference to FIG. 5 except for the locations of the identification unit 130 and the tag 140.

In the present embodiment, the electronic device 100d further includes a cable 150. The electronic device body 110 further comprises a first connector 118, and the cable 150 has a second connector 152, and the second connector 152 is capable of connecting to the first connector 118. Moreover, the identification unit 130 is disposed in the electronic device body 110 and is close to the first connector 118, and the tag 140 is disposed in the second connector 152. When the second connector 152 is connected to the first connector 118 and the second switch 114a is turned on by, for example, a press method, the identification unit 130 is capable of identifying the tag 140 to activate the electronic device body 110. The manner by which the identification unit 130 identifies the identification signal 140a is similar to that of the third embodiment, therefore it is not described again.

In addition, the first connector 118 is, for example, a power jack, and the second connector 152 is, for example, a power plug. However, the present invention is not limited to be used on power plug and the power jack thereof. For example, the first connector 118 is a RF port (radio frequency port), an AV port (audio/video port) or other signal line port, and the second connector 152 is then the corresponding signal line connector. As known by those skilled in the art, the “identification unit 130 is close to the first connector 118” or the similar description in the present invention refers to that the distance between the identification unit 130 and the first connector 118 is enough for the identification unit 130 to receive the identification signal 140a.

It should be noted that since the remote unit 120 of the present embodiment only has remote control function and has no anti-theft function, therefore the electronic device 100d of the present embodiment may not have the remote unit 120, the wireless signal transmitter 126 and the wireless signal receiver 112.

Referring to FIG. 6 and FIG. 8, when the second connector 152 is connected to the first connector 118, users also press the first switch 122 of the remote unit 120 to make the identification unit 130 identify the tag 140 to activate the electronic device body 110. The manner that the identification unit 130 identifies the identification signal 140a is similar to that of the second embodiment, therefore it is not described again.

Accordingly, before users activate the electronic device body 110 by pressing the first switch 122 or the second switch 114a, the corresponding second connector 152 has to be connected to the first connector 118 first, so that the identification unit 130 identifies the tag 140. Therefore, users just need to store the cable 150 in a safe place to reduce the theft rate of the electronic device 100d.

FIG. 9 is a block diagram of an electronic device with an active RF tag according to a fifth embodiment of the present invention. Referring to FIG. 6 and FIG. 9, the electronic device 100f of the fifth embodiment is similar to the electronic device 100d of the fourth embodiment described with reference to FIG. 7 except for the tag 140 (of the electronic device 100f) is an active RF tag.

When the identification signal 140a transmitted by the tag 140 is within the reading range of the identification unit 130, and users press the first switch 122 or the second switch 114a, the identification unit 130 receives and identifies the identification signal 140a. The manner that identification unit 130 identifies the identification signal 140a is similar to that of the first embodiment, therefore it is not described.

It should be noted that since the remote unit 120 of the present embodiment only has remote control function and has no anti-theft function, therefore the electronic device 100f of the present embodiment may not have the remote unit 120, the wireless signal transmitter 126 and the wireless signal receiver 112.

Besides, since the present invention is also used in inventory control, goods tracking or supply chain management and the like by using the identification signal 140a transmitted by the tag 140. For example, since each individual electronic device comprises a RF tag, and the different RF tags are capable of transmitting different identification signals respectively, therefore users just need to use one RF identification device to identify these identification signals respectively to acquire the device information of each electronic device. Then, users compare the device information of each electronic device with the device information in a database to achieve inventory control and management of the electronic device.

To sum up, the electronic device of the present invention has at least one or more or all of the following advantages:

Since when users press the first switch or the second switch, the identification unit has to identify the corresponding tag first, then the electronic device body is activated, therefore users just need to store the remote unit or the cable in safe place, thus the electronic device body can't be activated. Therefore the present invention effectively reduces the theft rate of electronic device body.

The electronic device comprises a remote unit, so users use the remote unit to control the electronic device body, and thereby increase the convenience of operations.

The electronic device has both a remote unit and a keypad, so as to provide diversifications to the operations of the electronic device body.

When the remote unit is disposed in the recess of the electronic device body, the battery of the remote unit is charged through the electronic device body to reduce the frequent change of the remote unit battery.

Users identify the identification codes of different electronic devices respectively through a RF identification device and to compare the device information of different electronic devices with the device information in database, and thereby achieve inventory control, goods tracking or supply chain management of the electronic devices.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An electronic device, comprising:
an electronic device body;
a remote unit, having a first switch;
an identification unit, disposed in the electronic device body; and
a tag, disposed in the remote unit, when the remote unit is close to the electronic device body, and the first switch is turned on, the identification unit identifying the tag to activate the electronic device body.

2. The electronic device of claim 1, wherein the identification unit comprises a radio frequency identification unit, and the tag comprises a radio frequency tag, and the radio frequency identification unit identifies an identification signal transmitted by the radio frequency tag.

3. The electronic device of claim 2, wherein the radio frequency identification unit is capable of transmitting a radio frequency signal, the radio frequency tag is capable of receiving the radio frequency signal and transmitting the identification signal.

4. The electronic device of claim 2, wherein the radio frequency tag comprises an active radio frequency tag or a passive radio frequency tag.

5. The electronic device of claim 2, wherein the identification unit comprises a storage unit for storing an identification code of the tag, and the identification unit is capable of comparing the identification signal and the identification code, when it is determined that the identification signal is same as the identification code, the electronic device body is activated.

6. The electronic device of claim 1, wherein the electronic device body has a recess and the remote unit is disposed in the recess.

7. The electronic device of claim 6, wherein the remote unit comprises a battery, when the remote unit is disposed in the recess, the battery is charged through the electronic device body.

8. The electronic device of claim 1, wherein the electronic device comprises a keypad disposed on the electronic device body, and is capable of controlling the electronic device body.

9. The electronic device of claim 8, wherein the keypad comprises a second switch, when the remote unit is close to the electronic device body and the second switch is turned on, the identification unit identifies the tag and activates the electronic device body.

10. The electronic device of claim 1, wherein the remote unit comprises a wireless signal transmitter, and the electronic device body comprises a wireless signal receiver, and a wireless signal is transmitted between the wireless signal transmitter and the wireless signal receiver.

11. The electronic device of, claim 10, wherein the wireless signal transmitter comprises an infrared transmitter, and the wireless signal receiver comprises an infrared receiver, and the wireless signal comprises an infrared signal.

12. An electronic device, comprising:
an electronic device body, comprising a switch and a first connector;
a cable, comprising a second connector for connecting to the first connector;
an identification unit, disposed in the electronic device body and close to the first connector; and
a tag, disposed in the second connector, when the second connector is connected to. the first connector, and the switch is turned on, the identification unit identifying the tag to activate the electronic device body.

13. The electronic device of claim 12, wherein the identification unit comprises a radio frequency identification unit, and the tag comprises a radio frequency tag, and the radio frequency identification unit identifies an identification signal transmitted by the radio frequency tag.

14. The electronic device of claim 13, wherein the radio frequency identification unit is capable of transmitting a radio frequency signal and the radio frequency tag is capable of receiving the radio frequency signal and transmitting the identification signal.

15. The electronic device of claim 13, wherein the radio frequency tag comprises an active radio frequency tag or a passive radio frequency tag.

16. The electronic device of claim 13, wherein the identification unit comprises a storage unit for storing an identification code of the tag, and the identification unit capable of comparing the identification signal and the identification code, when it is determined that the identification signal is same as the identification code, the electronic device body is activated.

17. The electronic device of claim 12, further comprising a remote unit having another switch, when the second connector is connected to the first connector, and the switch of the remote unit is turned on, the identification unit identifies the tag to activate the electronic device body.

18. The electronic device of claim 17, wherein the electronic device body has a recess and the remote unit is disposed in the recess.

19. The electronic device of claim 18, wherein the remote unit comprises a battery, when the remote unit is disposed in the recess, the battery is charged through the electronic device body.

20. The electronic device of claim 17, wherein the remote unit comprises a wireless signal transmitter, and the electronic device body comprises a wireless signal receiver, and a wireless signal is transmitted between the wireless signal transmitter and the wireless signal receiver.

21. The electronic device of claim 20, wherein the wireless signal transmitter comprises an infrared transmitter, and the wireless signal receiver comprises an infrared receiver, and the wireless signal comprises an infrared signal.
